(19) United States
(12) Patent Application Publication
(10) Pub. No.: US 2017/0199498 A1
(43) Pub. Date: Jul. 13, 2017

(54) LED NOTIFICATION WATCH

(71) Applicant: SILVERPLUS, INC., IRVINE, CA (US)

(72) Inventors: Chih-Chang HSIEH, IRVINE, CA (US); Te-Hsiu CHIU, Taipei (TW); Ming-Yish CHEN, Taipei (TW)

(73) Assignee: SILVERPLUS, INC

(21) Appl. No.: 15/343,390

(22) Filed: Nov. 4, 2016

Related U.S. Application Data
(60) Provisional application No. 62/275,896, filed on Jan. 7, 2016.

(51) Int. Cl. G04G 9/00

(52) U.S. Cl. CPC G04G 9/0064

(57) ABSTRACT

The present disclosure discloses a timekeeping apparatus, comprising: a case; a display area on a side of the case; a light source near the display area, the light source being capable of emitting light with different colors to indicate different types of messages received by the timekeeping apparatus.

### TECHNICAL FIELD

The present disclosure generally relates to timekeeping devices, and, more specifically to smart watches.

### BACKGROUND

Smart watches usually have a display panel (such as LED and OLED types) to display messages (such as notifications) coming from other devices such as smartphones. However, the display panel consumes a significant amount of energy and may be one of the most energy-consuming components of a smart watch. FIG. 1 illustrates a smart watch that turns on the entire display panel to display messages/notifications.

### SUMMARY OF INVENTION

In accordance with an embodiment of the present disclosure, a timekeeping apparatus, such as a watch, is provided. The timekeeping apparatus comprises a case, a display area on a side of the case, and a light source near the display area, the light source being capable of emitting light with different colors to indicate different types of messages received by the timekeeping apparatus. The colors allow the wearer of the timekeeping apparatus to determine the type/importance of the incoming messages without the need of turning on the entire display panel, leading to more power saving and reducing recharging frequency.

In an embodiment, the display area is on a sidewall of the timekeeping apparatus. In an embodiment, the display area is near a six o'clock sign of the timekeeping apparatus. The sidewall and the six o'clock sign are right in the view angle of the wearer to let he/she easily see whether the light source is on and determine the type/importance of the incoming messages from the color of the light. Additionally, arranging the light source near the six-o'clock sign of the timekeeping apparatus would not negatively affect the assembly of the remaining components of the timekeeping apparatus. In other embodiments, the light source may also be arranged anywhere around the case of the timekeeping apparatus.

In an embodiment, the display area is an arc or a ring on the sidewall. The length of the arc and/or the width of the ring may be adjusted based on the desired amount of the display area, thereby providing more flexibility to the designer of the timekeeping apparatus to achieve sufficient illumination from the display area.

In an embodiment, the display area comprises a hole. The light emitted from the light source near the display area may easily leave the timekeeping apparatus. In an embodiment, the hole and/or the whole display area is filled with an at least semi-transparent material. The at least semi-transparent material also allows the light emitted from the light source to leave the timekeeping apparatus while providing possibilities to further adjust the intensity and/or color of the light as well as the color of the display area.

In accordance with an embodiment of the present disclosure, a timekeeping apparatus is provided. The timekeeping apparatus comprises a case, an upper surface comprising a rim, a display area, and a light source near the display area, wherein the light source is capable of emitting light with different colors to indicate different types of messages received by the timekeeping apparatus, and wherein the display area is on the rim. Since the rim is on the upper surface, the display area is well within the view angle of the wearer of the timekeeping apparatus, thereby making it easy for the wearer to discern the intensity and/or color of the light emitted from the display area.

In an embodiment, the display area comprises an arc on the rim. In an embodiment, the display area is substantially the entirety of the rim. This flexibility in adjusting the length and/or area of the display area may allow further optimization of the power consumption of the light source and a higher degree in product customization (e.g., the manufacturer of the timekeeping apparatus may appeal to a wider range of clientele with different needs for functionality and/or aesthetic appeal).

### BRIEF DESCRIPTION OF THE DRAWINGS

FIG. 1 illustrates a prior art smart watch.

FIG. 2 illustrates a watch according to an embodiment of the present disclosure.

FIG. 3 illustrates some inner components of a watch according to an embodiment of the present disclosure.

FIG. 4 illustrates a watch according to an embodiment of the present disclosure.

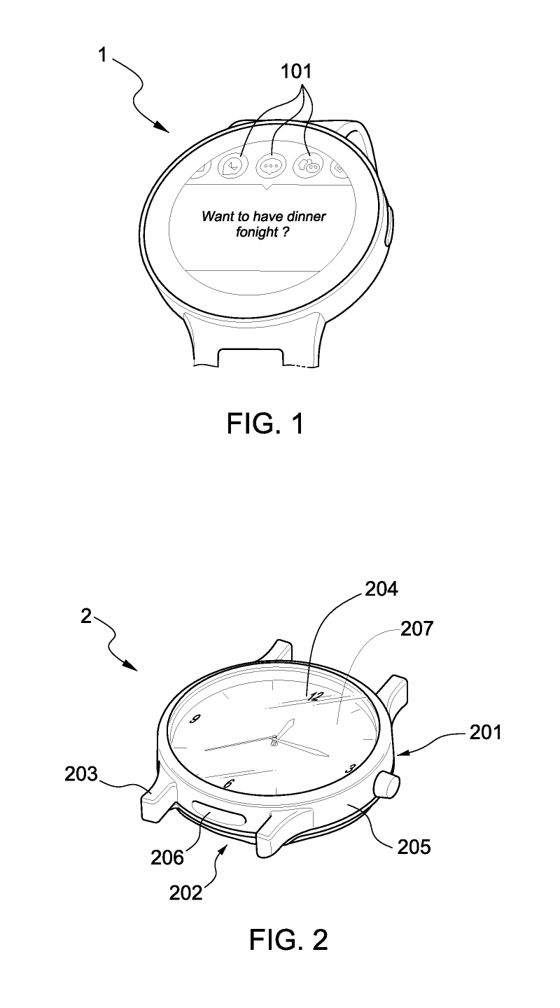

### DETAILED DESCRIPTION

The present disclosure can be better understood with reference to the description below and the accompanying drawings.

FIG. 2 illustrates a watch 2 according to an embodiment of the present disclosure. The watch 2 may be a smart watch. The watch 2 comprises a case 201 comprising a sidewall 205, a display area 202, at least one lug 203, an upper surface 204, a hole 206 on the sidewall 205, and a display 207. The case 201 is usually made of a material hard enough to enclose and protect the components of the watch 2 inside. The upper surface 204 may be of a material identical to or different from the case 201. In some embodiments, the upper surface 204 is made of an at least semi-transparent material, such as glass, acrylic and plastics. The case 201 and the upper surface 204 are tightly (preferably air-tight) combined so as to protect the components inside. In some embodiments, the case 201 and the upper surface 204 are integrally formed. The size of the sidewall 205 is usually determined by the thicknesses of the case 201 and/or the display 207. The display 207 may comprise a digitally controllable display panel. The digitally controllable display panel may be an LCD panel, an LED panel, an OLED panel, an organic luminescent display panel, a plasma display panel or an electronic ink panel.

The display area 202 is on a side of the case 201. A light source (not shown in FIG. 2) that can emit light with different colors may be arranged near the display area 202. In some embodiments, the colors vary according to the type of the messages received by the watch 2. In some embodiments, the display area 202 is on the sidewall 205. In the embodiment of FIG. 2, the display area 202 comprises a hole 206 on the sidewall 205, so light with different colors may be emitted from the hole 206. Thus, the wearer of the watch 2 may determine the type of the incoming messages by the color emitted from the display area 202 without the need to turn on the entire display 207 of the watch 2. Since the entire display 207 does not have to be turned on to make the wearer determine the type (and possibly importance) of the incoming messages, the battery life of the watch 2 can be extended.

In some embodiments, the display area 202 is an arc on the sidewall 205. The length of the arc may be adjusted according to different needs. In the embodiment of FIG. 2, the display area 202 takes the shape of an arc with a length less than the distance between the two lugs 203. In some embodiments, the length of the display area 202 may be much wider, up to, i.e., the circumference of the case 201, in which case the display area 202 becomes a ring.

The display 207 may display numerals indicating the hours, such as Arabic numerals (e.g., 3, 6, 9 and 12) and Roman numerals (e.g., III, VI, IX, XII). Indices may replace numerals to indicate the hours. In some embodiments, numerals and/or indices are additionally arranged on the display 207, instead of the display 207 displaying numerals and/or indices. In the embodiment of FIG. 2, the display area 202 comprising the hole 206 is arranged on one side of the case 201 near the six-o'clock sign between the lugs 203. In some embodiments, the hole 206 may be filled with a material that is at least semi-transparent, such as glass, acrylic, plastics and the like.

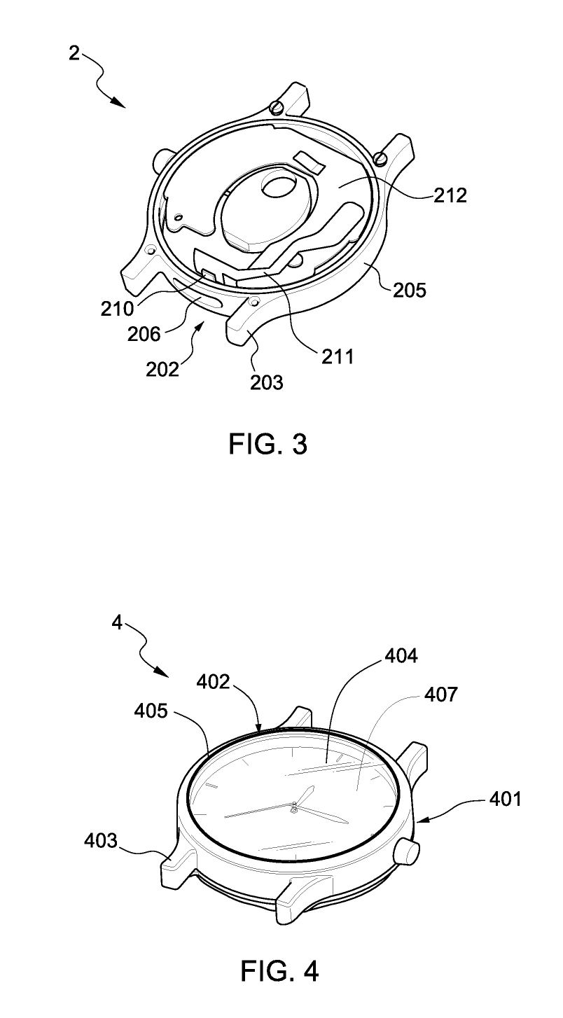

FIG. 3 illustrates some inner components of the watch 2 according to an embodiment of the present disclosure. One or more light sources 210 (such as LED, laser devices, fluorescent lamp, etc.) that may emit light with different colors exist behind the display area 202. The wearer may determine the type/importance of incoming messages based on the different colors of the light coming out of the display area 202. The one or more light sources 210 may be mounted on the main printed circuit board 212 (PCB) that carries the major components of the watch 2, or may be connected to the main PCB 212 by other types of connection 211 (such as wires and buses). In order to provide more easily discernible light, the light sources 210 may be mounted in such a way as to make them as close to the display area 202 as possible.

FIG. 4 illustrates a watch 4 according to an embodiment of the present disclosure. In an embodiment, the watch 4 may be a smart watch. The watch 4 comprises a case 401, a display area 402, at least one lug 403, an upper surface 404 comprising a rim 405, and a display 407. The watch 4 may also comprise at least one light source 210 (not shown in FIG. 4) placed near the display area 402. The watch 4 in FIG. 4 is similar to the watch 2 in FIGS. 2 and 3, so the following description will only emphasize the differences between them.

The display area 402 is at least semi-transparent such that light emitted from the light source 210 may be easily discerned by the wearer of the watch 4. In some embodiments, the display area 402 comprises an arc of the rim 405 that is at least semi-transparent. The at least semi-transparent materials may comprise glass, acrylic, plastics and/or the like. In some embodiments, the display area 402 is substantially the entirety of the rim 405 (i.e., the entire circumference of the rim 405). Being on the rim 405, the display area 402 is well within the view angle of the wearer of the watch 4, making it easy for the wearer to discern the color of the light emitted from the display area 402. The longer the display area 402 is, the easier it is for the wearer to notice the light and discern the color.

Specific components of a light notification smart watch and related manufacturing methods have been described. It should, however, be apparent to those skilled in the art that many more modifications besides those already described are possible without departing from the inventive concepts herein. The inventive subject matter, therefore, is not to be restricted except in the spirit of the present disclosure. Moreover, in interpreting the present disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

### LIST OF REFERENCE NUMERALS

1 watch
101 notification
2 watch
201 case
202 display area
203 lug
204 upper surface
205 sidewall
206 hole
207 display
210 light source
211 connection
212 printed circuit board
4 watch
401 case
402 display area
403 lug
404 upper surface
405 rim

We/I claim:

1. A timekeeping apparatus, comprising:
a case;
a display area on a side of the case;
a light source near the display area, the light source being capable of emitting light with different colors to indicate different types of messages received by the timekeeping apparatus.

2. The timekeeping apparatus of claim 1, wherein the display area is on a sidewall of the timekeeping apparatus.

3. The timekeeping apparatus of claim 2, wherein the display area is near a six o'clock sign of the timekeeping apparatus.

4. The timekeeping apparatus of claim 2, wherein the display area is an arc or a ring on the sidewall.

5. The timekeeping apparatus of claim 1, wherein the display area comprises a hole.

6. The timekeeping apparatus of claim 5, wherein the hole is filled with an at least semi-transparent material.

7. The timekeeping apparatus of claim 6, wherein the at least semi-transparent material comprises at least one of glass, acrylic and plastics.

8. The timekeeping apparatus of claim 1, wherein the display area is in the view angle of
a wearer of the timekeeping apparatus.

9. A timekeeping apparatus, comprising:
a case;
an upper surface, the upper surface comprising a rim;
a display area; and
a light source near the display area, the light source being capable of emitting light with different colors to indicate different types of messages received by the timekeeping apparatus;
wherein the display area is on the rim.

10. The timekeeping apparatus of claim 9, wherein the display area comprises an arc on the rim.

11. The timekeeping apparatus of claim 9, wherein the display area is substantially the entirety of the rim.
